(19) United States
(12) Patent Application Publication
(10) Pub. No.: US 2013/0159100 A1
(43) Pub. Date: Jun. 20, 2013

(54) SELECTING ADVERTISEMENTS FOR USERS OF A SOCIAL NETWORKING SYSTEM USING COLLABORATIVE FILTERING

(71) Applicants: Rajat Raina, Mountain View, CA (US); Gokul Rajaram, Los Altos, CA (US); Hong Ge, Cupertino, CA (US); Junfeng Pan, Santa Clara, CA (US); John Hegeman, Palo Alto, CA (US)

(72) Inventors: Rajat Raina, Mountain View, CA (US); Gokul Rajaram, Los Altos, CA (US); Hong Ge, Cupertino, CA (US); Junfeng Pan, Santa Clara, CA (US); John Hegeman, Palo Alto, CA (US)

(21) Appl. No.: 13/330,502

(22) Filed: Dec. 19, 2011

(51) Int. Cl. G06Q 30/02

(52) U.S. Cl. 705/14.52

(57) ABSTRACT

A social networking system selects advertisements for its users using collaborative filtering based on the users' interactions with objects in the social networking system. The objects may be games, pages, groups, deals, messages, content items, advertisements, or any other object with which a user may interact in the system. The system may identify a viewing user's interaction with a first object, determine a second object that is similar to the first object based on interactions of users with both of the objects, and send an advertisement associated with the second object to the viewing user. The system determines a second object based a similarity score between the first object and the second object, which may be a measure of users who have interacted with both objects and may be normalized by a number of user interactions by the users with the objects.

### BACKGROUND

This invention relates generally to social networking, and in particular to advertising about objects in a social networking system to users using collaborative filtering based on the users' interactions with objects in the social networking system.

Traditional advertisers have relied on massive lists of keywords to target audiences based on their interests. For example, a sports drink advertiser may target audiences that are interested in sports, such as baseball, basketball, and football, among others. However, advertisements may be presented in locations and at times where the audiences are not actively engaging in an activity related to the product. This leads to wasted ad spending because audiences may not pay attention to the advertisement for lack of relevance.

In recent years, social networking systems have made it easier for users to share their interests and preferences in real-world concepts, such as their favorite movies, musicians, celebrities, brands, hobbies, sports teams, and activities. These interests may be declared by users in user profiles and may also be inferred by social networking systems. Users can also interact with these real-world concepts through multiple communication channels on social networking systems, including interacting with pages on the social networking system, sharing interesting articles about causes and issues with other users on the social networking system, and commenting on actions generated by other users on objects external to the social networking system. Although advertisers may have some success in targeting users based on interests and demographics, tools have not been developed to select advertisements for users using collaborative filtering.

Specifically, social networking systems do not infer objects that a viewing user is likely interested in based on interactions of users who have similar interests to the viewing user. A social networking system may have millions of users that have interacted with a multitude of objects, such as movies, songs, celebrities, brands, sports teams, and the like. However, existing systems have not provided efficient mechanisms of selecting advertisements for users using collaborative filtering.

### SUMMARY

A social networking system selects advertisements for its users using collaborative filtering based on the users' interactions with objects in the social networking system. The objects may be games, pages, groups, deals, messages, content items, advertisements, or any other object with which a user may interact in the system. The system may identify a viewing user's interaction with a first object, determine a second object that is similar to the first object based on interactions of users with both of the objects, and send an advertisement associated with the second object to the viewing user. The system determines a second object based on the similarity score between the first object and the second object, which may be a measure of users who have interacted with both objects and may be normalized by the number of user interactions by the users with the objects.

### BRIEF DESCRIPTION OF THE DRAWINGS

FIG. 1 is a high level block diagram illustrating a process of selecting advertisements for users of a social networking system using collaborative filtering, in accordance with one embodiment of the invention.

FIG. 2 is a high level block diagram of a system environment suitable for selecting advertisements for users of a social networking system using collaborative filtering, in accordance with one embodiment of the invention.

FIG. 3A is an example of a user-object interaction matrix with binary values, in accordance with one embodiment of the invention.

FIG. 3B is an example of a user-object interaction matrix with interest values, in accordance with one embodiment of the invention.

FIG. 4 is a flow chart illustrating a process for selecting advertisements for users of a social networking system using collaborative filtering, in accordance with an embodiment of the invention.

The figures depict various embodiments of the described methods and system and are for purposes of illustration only. One skilled in the art will readily recognize from the following discussion that alternative embodiments of the methods and systems illustrated herein may be employed without departing from the principles of the methods and systems described herein.

### DETAILED DESCRIPTION

### Overview of Social Networking Systems

Online social networking systems comprise one or more computing devices storing a social network, or a social graph, comprising a plurality of users and providing users of the social networking system with the ability to communicate and interact with other users of the social networking system. Social networking systems allow users to explicitly associate themselves and establish connections with other users of the social networking system. When two users become connected, they are said to be “friends,” “contacts,” “connections,” or “associates” within the context of the social networking system. Alternatively, connections may be automatically created by the social networking system based on common characteristics of the users (for example, users who have had a common employer, have a common friend, or like a common film). Generally, being connected in a social networking system allows connected users access to more information about each other than would otherwise be available to unconnected users. Likewise, becoming connected within a social networking system may allow a user greater access to communicate with another user, such as by email (internal and external to the social networking system), instant message, text message, phone, or any other communicative interface. Finally, being connected may allow a user access to view, comment on, download or endorse another user's uploaded content items. Examples of content items include but are not limited to messages, queued messages (e.g., email), text and SMS (short message service) messages, comment messages, messages sent using any other suitable messaging technique, an HTTP link, HTML files, images, videos, audio clips, documents, document edits, calendar entries or events, other user-generated content, and other computer-related files.

Online social networking systems may track objects through the use of a social graph, which includes a plurality of nodes that are interconnected by a plurality of edges. In the social graph, nodes represent objects within the context of the social networking system. Common examples of objects include users, content items, groups, web pages, fan pages, events, messages, concepts, interactions, information, activities, data, computer applications, advertisements, or any other entity capable of being represented in a social networking system. Companies, locations, venues, merchants, bands, non-user persons, restaurants, or any other entities may be directly represented by a social networking system object, or may be indirectly represented by an object via a group, web page or fan page within the social networking system dedicated to the entity. For instance, the restaurant “Refuge” or the venue “Orpheum Theatre” may have dedicated objects within the social networking system; alternatively, Refuge may have a fan page and the Orpheum Theatre may have a web page on the social networking system.

An edge between nodes in the social graph represents a particular kind of connection between the two nodes, which may result from an interaction that occurred between the nodes. For instance, for two nodes that represent users, an edge may imply that the users are friends within the context of the social networking system. Alternatively, an edge may imply that the users have communicated with each other, that one user may have viewed the other's profile, that the users attended the same high school, or any other means of connection or interaction. For two nodes where at least one node does not represent a user, an edge may imply similar or different connections or interactions. For example, an edge may indicate a user clicked the “like” button for a group dedicated to a particular band, or that a user clicked on an advertisement. Alternatively, an edge may indicate that two companies, each represented by a social networking system web page, are associated with each other despite no explicit action by either company.

When a new object of a particular type is created, the social networking system may initialize a new node of the corresponding type, may assign a unique object or node identifier to it, and may begin to add data to the object as needed. This might occur, for example, when an individual first becomes a user of the social networking system, when the social networking system generates a new user profile, when a user starts a new group, when a new content item is uploaded to the social networking system, or any other time an object is added to or created within the social networking system. When a new object is created, an edge may be created linking the object node to the node representing the user who created the object. In addition, the social networking system may link the new object node or any existing nodes to other social graph nodes automatically. For instance, if a first user uploads a photograph of a sports bar to the social networking system, and afterwards, a fan page for the sports bar is created, the social networking system may provide an edge between the user node and the fan page node without explicit action by a user. Further, if a second user posts a comment about going to the sports bar on a third user's profile, the second user's and third user's nodes may be automatically connected to the sports bar node without explicit action by either user in regards to the sports bar node.

Users of social networking systems may interact with social networking system objects in a variety of forms, such as by communicating with or commenting on a content item, information or action; clicking a button or link associated with approval (such as a “like” button or the equivalent); sharing a content item, user information or user actions with other users; or downloading or merely viewing a content item. Interaction may also comprise using a computer-based application within the context of the social networking system (such as a video game only accessible and playable from within the social networking system), or an application external to the social networking system (such as a desk top web browser or mobile application) that may or may not interface with the social networking system. Further, interactions also include making a purchase, either in the context of the social networking system, or external to the social networking system; joining, commenting on or subscribing to a social networking system group, web page or fan page; using a mobile device to transmit a current or past location to the social networking system (“checking in” to a location); scheduling a meeting, gathering, errand, vacation, task, objective, reservation, date, or any other event or calendar entry; and accepting an invitation to or indicating the intent to attend a meeting, gathering, party, concert, play, or any other event. For instance, a user may join a group dedicated to Chopin, may buy tickets to a Chopin performance, may check into the concert hall when the user arrives at the performance, and may post a note to the user's profile reviewing the performance, all of which constitute interactions.

Users of social networking systems may also interact with other users by associating with, connecting to or becoming friends with them, by viewing their profile, by communicating with them, or by having common friends within the social networking system. In addition, a social networking system user may interact with content items, websites, other users, or other information outside of the context of the social networking system's web pages that are connected to or associated with the social networking system. For instance, an article on a news web site might have a “like” button that users of the social networking system can click on to express approval of the article. Likewise, a company's website may provide the ability to join a social networking system group dedicated to the company directly from the company's website. These interactions and any other suitable actions within the context of a social networking system may be recorded in social networking system data, which can be used to generate social endorsement information. The social endorsement information may comprise text, images, links, and/or be of any suitable form necessary to convey social endorsement information to a user.

### Process Overview

Advertisers may engage with users of a social networking system through different communication channels, including direct advertisements, such as banner ads; indirect advertisements, such as sponsored stories; generating a fan base for a page on the social networking system; and developing applications that users may install on the social networking system. An advertiser would benefit from a system that selects advertisements using collaborative filtering because the selected advertisements are more likely to be relevant to users. In turn, a social networking system would benefit from increased advertising revenue by providing relevant advertisements.

The social networking system disclosed herein uses collaborative filtering to infer objects that a user is likely interested in and serves advertisements associated with the inferred objects. Based on the viewing user's interaction with object A, collaborative filtering infers object B if users who interacted with object A also liked object B. The underlying assumption of this approach is that those who agreed in the past tend to agree again in the future.

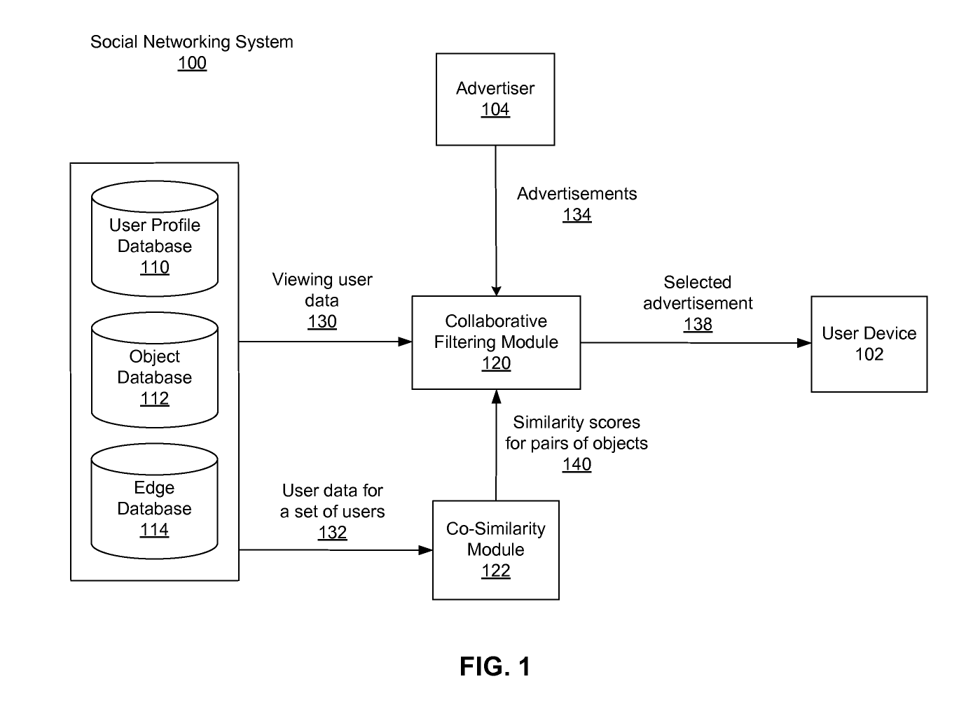

FIG. 1 is a diagram of a system environment for selecting advertisements for users of a social networking system using collaborative filtering, in accordance with one embodiment. As illustrated in FIG. 1, the collaborative filtering module 120 receives viewing user data 130, advertisements 134, and similarity scores for pairs of objects 140. Using the viewing user data 130 and the similarity scores for pairs of objects 140, the collaborative filtering module 120 selects an advertisement to display to the viewing user.

The viewing user data 130 may include user profile objects and edge objects. User profile objects include declarative profile information about the viewing user. Edge objects include information about the viewing user's interactions with other objects on the social networking system 100, such as clicking on a link shared with the viewing user, sharing photos with other users of the social networking system, posting a status update message on the social networking system 100, and other actions that may be performed on the social networking system. The similarity score measures the similarity between two objects and represents the likelihood that a user would be interested in one of the objects.

The similarity scores for pairs of objects 140 are provided to the collaborative filtering module 120 by the co-similarity module 122. The co-similarity module 122 uses user data for a set of users 132 to determine similarity scores for pairs of objects. The user data for the set of users 132 includes user profile objects and edges object for the set of users. The set of users may correspond to a segment of users defined by demographic characteristics such as age, gender, or geographic location.

An advertiser 104 is an entity that provides advertisements 134 to the collaborative filtering module 120. In one embodiment, an advertisement is a web-based ad that is displayed in the margins or other dedicated area of a website. The advertisements may include banners ads, floating ads, expanding ads, wallpaper ads, pop-up ads, pop-under ads, video ads, map ads, animations, email ads, and mobile ads. In some embodiments, each of the advertisements is associated with one or more objects of the social networking system.

The collaborative filtering module 120 identifies a first object the viewing user interacted with, selects a second object based on a similarity score between the objects, and selects an advertisement associated with the second object to send to the user device 102 of the viewing user for display. The viewing user may be identified by a user identifier that correlates to the user profile for the viewing user. The user identifier may be received when the user requests a page of the social networking system or opens a native application.

The collaborative filtering module 120 identifies an object that the viewing user interacted with from the viewing user data 130. For example, the viewing user may play a game or view a content item. In some embodiments, the collaborative filtering module 120 sends a reference to the identified object to the co-similarity module 122. In response to the request, the collaborative filtering module 120 may receive a reference to a single object or references and scores for multiple objects. In some embodiments, the collaborative filtering module 120 receives multiple sets of object scores, where each set was determined based on data for a segment of users.

The collaborative filtering module 120 selects a second object based on a similarity score between the second object and a first object the viewing user interacted with. The collaborative filtering module 120 examines the similarity scores between the first object and other objects and selects an object based on the similarity scores. In some embodiments, the collaborative filtering module 120 selects an object having the highest score with the first object. In some embodiments, the collaborative filtering module 120 selects an object having a similarity score above a threshold. The collaborative filtering module 120 retrieves an advertisement associated with the selected object and sends the advertisement to the viewing user.

### System Overview

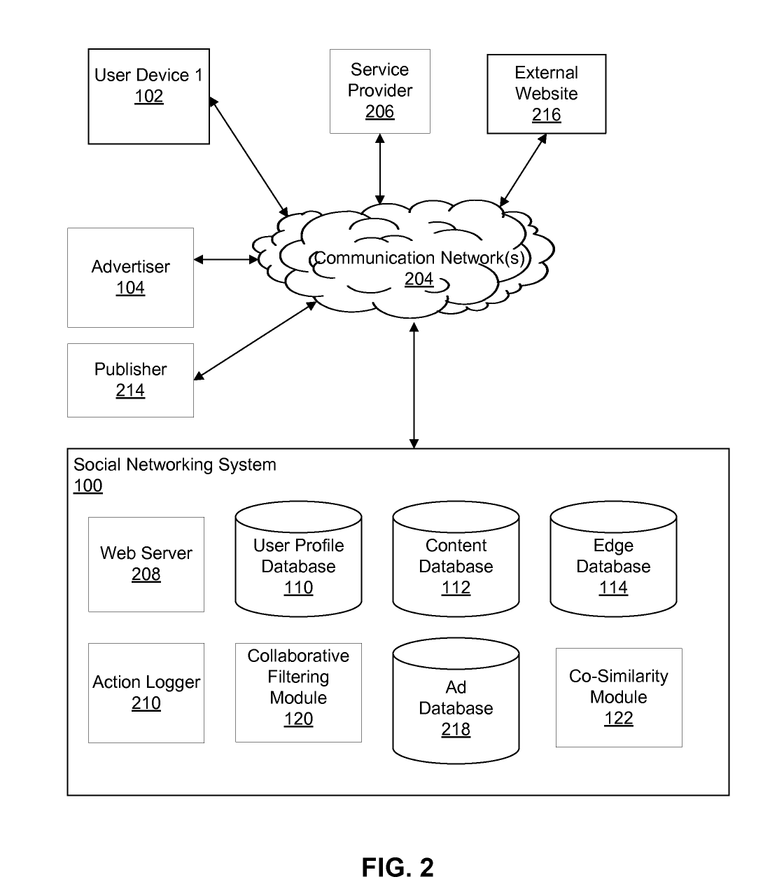

FIG. 2 is a high level block diagram illustrating a system environment suitable for selecting advertisements for users of a social networking system using collaborative filtering, in accordance with one embodiment. The system environment comprises one or more user devices 102, the social networking system 100, a network 204, and external websites 216. In alternative configurations, different and/or additional modules can be included in the system. In some embodiments, the social networking system 100 is implemented as a single server, while in other embodiments it is implemented as a distributed system of multiple servers. For convenience of explanation, the social networking system 100 is described below as being implemented on a single server system.

The communication network(s) 204 can be any wired or wireless local area network (LAN) and/or wide area network (WAN), such as an intranet, an extranet, or the Internet. It is sufficient that the communication network 204 provides communication capability between the user devices 102 and the social networking system 100. In some embodiments, the communication network 204 uses the HyperText Transport Protocol (HTTP) and the Transmission Control Protocol/Internet Protocol (TCP/IP) to transmit information between devices or systems. HTTP permits the user devices 102 to access various resources available via the communication network 204. The various embodiments of the invention, however, are not limited to the use of any particular protocol.

The user devices 102 comprise one or more computing devices that can receive user input and can transmit and receive data via the network 204. In one embodiment, the user device 102 is a conventional computer system executing, for example, a Microsoft Windows-compatible operating system (OS), Apple OS X, and/or a Linux distribution. In another embodiment, the user device 102 can be a device having computer functionality, such as a personal digital assistant (PDA), mobile telephone, smart-phone, etc. The user device 102 is configured to communicate via network 204. The user device 102 can execute an application, for example, a browser application that allows a user of the user device 102 to interact with the social networking system 100. In another embodiment, the user device 102 interacts with the social networking system 100 through an application programming interface (API) that runs on the native operating system of the user device 102, such as iOS and ANDROID.

A service provider 206 includes any entity that provides data or an online service to a user over a network, including but not limited to social networking systems, web retailers, news providers, video content item providers, etc. The embodiments disclosed herein may include one or more service providers 206.

A publisher 214 is an entity that sends an advertisement to a user device 102 for display to a viewing user. A publisher 214 may include, for example, a service provider 206 such as a newspaper, a video content provider, a web retailer, an email service provider, or a social networking system. In one embodiment, the publisher 214 receives an advertisement provided by the social networking system 100 and sends the advertisement to a user device 102 for display.

The web server 208 links the social networking system 100 via the network 204 to one or more user devices 102; the web server 208 serves web pages, as well as other web-related content, such as Java, Flash, XML, and so forth. The web server 208 may provide the functionality of receiving and routing messages between the social networking system 100 and the user devices 102, for example, instant messages, queued messages (e.g., email), text and SMS (short message service) messages, or messages sent using any other suitable messaging technique. The user can send a request to the web server 208 to upload information, for example, images or videos that are stored in the content database 112. Additionally, the web server 208 may provide API functionality to send data directly to native user device operating systems, such as iOS, ANDROID, webOS, and BlackBerry OS.

The action logger 210 is capable of receiving communications from the web server 208 about user actions on and/or off the social networking system 100. The action logger 210 populates an action log with information about user actions to track them. Such actions may include, for example, adding a connection to the other user, sending a message to the other user, uploading an image, reading a message from the other user, viewing content associated with the other user, attending an event posted by another user, among others. In addition, a number of actions described in connection with other objects are directed at particular users, so these actions are associated with those users as well.

An action log may be used by a social networking system 100 to track users' actions on the social networking system 100 as well as external websites that communicate information back to the social networking system 100. As mentioned above, users may interact with various objects on the social networking system 100, including commenting on posts, sharing links, and checking-in to physical locations via a mobile device. The action log may also include user actions on external websites. For example, an e-commerce website that primarily sells luxury shoes at bargain prices may recognize a user of a social networking system 100 through social plug-ins that enable the e-commerce website to identify the user of the social networking system. Because users of the social networking system 100 are uniquely identifiable, e-commerce websites, such as this luxury shoe reseller, may use the information about these users as they visit their websites. The action log records data about these users, including viewing histories, advertisements that were clicked on, purchasing activity, and buying patterns.

User account information and other related information for users are stored as user profile objects in the user profile database 110. The user profile information stored in user profile database 110 describes the users of the social networking system 100, including biographic, demographic, and other types of descriptive information, such as work experience, educational history, gender, hobbies or preferences, location, and the like. The user profile may also store other information provided by the user, for example, images or videos. In certain embodiments, images of users may be tagged with identification information of users of the social networking system 100 displayed in an image. The user profile database 110 also maintains references to the actions stored in an action log and performed on objects in the content database 112.

The edge database 114 stores the information describing connections between users and other objects on the social networking system 100 in edge objects. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 100, such as expressing interest in a page on the social networking system, sharing a link with other users of the social networking system, and commenting on posts made by other users of the social networking system. The edge database 114 stores edge objects that include information about the edge, such as affinity scores for objects, interests, and other users. Affinity scores may be computed by the social networking system 100 over time to approximate a user's affinity for an object, interest, and other users in the social networking system 100 based on the actions performed by the user. Multiple interactions between a user and a specific object may be stored in one edge object in the edge store 114, in one embodiment. For example, a user that plays multiple songs from Lady Gaga's album, “Born This Way,” may have multiple edge objects for the songs, but only one edge object for Lady Gaga.

The ad database 218 stores advertisements. In some embodiments, each advertisement is associated with one or more objects. In some embodiments, the ad database 218 stores ad campaigns that have one or more requests for advertisements and/or sponsored stories. In some embodiments, the ad database 218 stores sponsored stories. A sponsored story comprises an advertising message that communicates a message about at least one user action. A sponsored story, for example, may inform a user that a friend (or a number of friends) of the user has purchased a particular item made by an advertiser, will attend an event sponsored by an advertiser, or has added a connection to a profile for a business or other entity. Other examples of actions that may be described in a sponsored story may include checking in at a location, purchasing a product or service, joining a group, attending an event, using a third party application, playing a game, or expressing an affinity towards an object in the online system.

### Determining Similarity Scores for Pairs of Objects

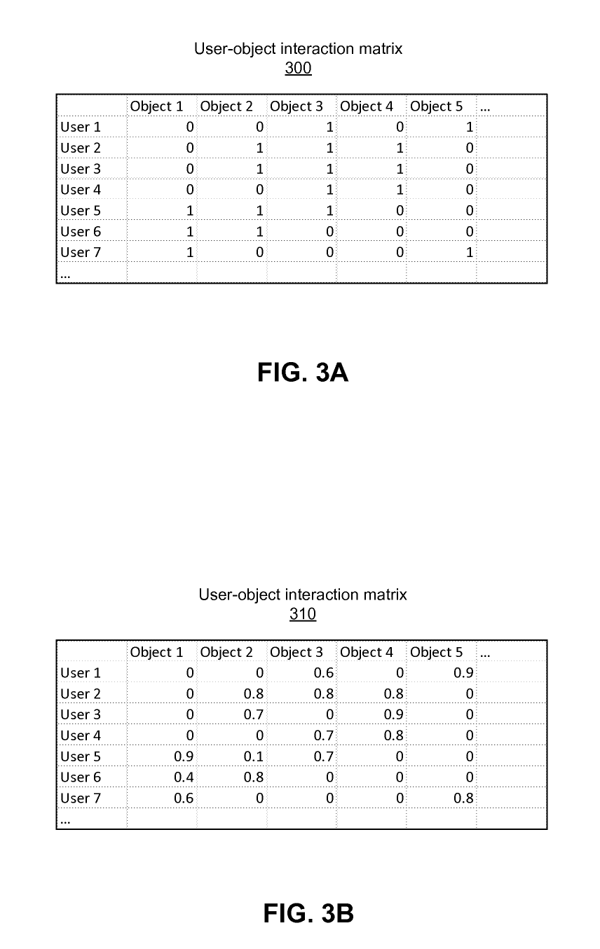

FIG. 3A illustrates a user-object interaction matrix 300 used by the co-similarity module 122 in computation of similarity scores for pairs of objects, in one embodiment. The matrix 300 is stored in the edge database 114 or in a distributed database as a user-object interaction matrix data structure. The rows of the matrix 300 correspond to users of the social networking system 100 and the columns of the matrix 300 correspond to objects in the social networking system 100. The elements in matrix 300 are binary values and each binary value corresponds to a user-object pair. A binary value is based on whether a user interacted with an object. For example, the binary value for a user-object pair may be zero when the user has not interacted with the object and the binary value may be one when the user interacted with the object. The binary value for User 1 and Object 1 is zero to indicate that User 1 had not interacted with Objet 1. The binary value for User 1 and Object 3 is one to indicate that User 1 interacted with Object 3.

The co-similarity module 122 determines similarity scores for each pair of objects in the matrix 300 and stores the similarity scores in the edge database 114. As discussed above, the similarity score measures the similarity between two objects and represents the likelihood that a user would be interested in one of the objects. In some embodiments, the similarity score for two objects is determined using Formula 1:

$$\frac{Object A ⋂ Object B}{\sqrt{( Object A ) ( Object B )}} \qquad ( Formula 1 )$$

In Formula 1, Object A represents the number of users who interacted with Object A and Object B represents the number of users who interacted with Object B. The numerator of Formula 1, Object A∩Object B, is the number of users who have interacted with both Object A and Object B. To compute a similarity score for Object 2 and Object 3, the numerator of Formula 1 would be the number of users who interacted with both Object 2 and Object (i.e., 3). As shown, in matrix 300, there are three users (i.e., User 2, User 3, and User 5) who have interacted with both Object 2 and Object 3.

The denominator of Formula 1 is the square root of the product of Object A (i.e., the number of users who interacted with Object A) and Object B (i.e., the number of users who interacted with Object B). The denominator normalizes the value of the numerator (i.e., the number of users who interacted with both objects) by the number of user interactions with one or both of the objects. For computing a similarity score for Object 2 and Object 3, the denominator of Formula 1 would be the square root of the product of the number of user interactions with Object 2 (i.e., 4) and the number of user interactions with Object 3 (i.e., 5). If only the first seven users of matrix 300 are considered, the similarity score for Object 2 and Object 3 using Formula 1 would be the number of users who interacted with both Object 2 and Object 3 (i.e., 3) divided by the square root of the product of the number of users who interacted with Object 2 and/or Object 3 (i.e., 4.47).

FIG. 3B illustrates a user-object interaction matrix 310 used by the co-similarity module 122 to compute similarity scores for pairs of objects, in another embodiment. The elements in matrix 310 are non-binary interest values, and each interest value corresponds to a user-object pair. An interest value measures a user's interest in an object and is based on the interaction scores of one or more user interactions with an object. An interest value may be a product or sum of interaction scores associate with each user interaction with an object. Each object has an associated set of interaction types and each interaction type has an associated interaction score. The co-similarity module 122 may store a table that includes scores for different types of interactions for respective objects. The table may, for example, store scores for different actions relating to a group object. In this example, the action of posting content to a group may be scored higher than the action of merely viewing the page of the group.

In some embodiments, the interest values in the matrix 310 are decayed based on a decay factor. The decay factor may cause a user's interactions to diminish slowly over time, or it may be a discrete decay that completely discounts any user interactions that are over a specified age. The decay factor may also depend on the type of user interaction. For example, a user interaction in which a user posts on a page may be decayed less than a user interaction in which a user merely views a post on a page.

In some embodiments, the co-similarity module 122 determines a similarity score for two objects in the matrix 310 using Formula 2:

$$\frac{{\sum }_{i = 1}^{n} ( Object {A}_{i} ) ( Object {B}_{i} )}{\sqrt{{\sum }_{i = 1}^{n} ( Object {A}_{i} ) ( Object {A}_{i} ) {\sum }_{i = 1}^{n} ( Object {B}_{i} ) ( Object {B}_{i} )}} \qquad ( Formula 2 )$$

The numerator of Formula 2, Σᵢ₌₁ⁿ (Object Aᵢ) (Object Bᵢ), is the sum of the product of the users' interest values for Object A and Object B, where Object Aᵢ and Object Bᵢ denote the i-th entry in the Object A and Object B columns, respectively, and n is the number of entries (rows) in the columns. For determining the similarity score for Object 3 and Object 4, for example, the numerator would be the sum of the product of User 1's interest values for Object 3 and Object 4, the product of User 2's interest values for Object 3 and Object 4, the product of User 3's interest values for Object 3 and Object 4, and so on. As a practical matter, in this example, only the interest values from User 2 and User 4 would contribute to the numerator since the other users have at least one interest value of zero for Object 3 or Object 4. The denominator of Formula 2 is the square root of the sum of the squares of interest values for Object A multiplied by the sum of the squares of interest values for Object B. For determining a similarity score for Object 3 and Object 4, the denominator would be the square root of the sum of the interest values of Object 3 (i.e., 1.98 or 0.6*.6+.8 *.8+.7*.7+.7*.7) multiplied by the sum of the interest values of Object 4 (i.e., 2.09 or 0.8*.8+.9*.9+.8*.8).

Depending on the number of users and objects, the matrices discussed above may be extremely large and distributed across multiple databases. In some embodiments that use large distributed databases, the co-similarity module 122 uses one or more map and reduce steps, such as in the MapReduce software framework, to compute the similarity scores between pairs of objects. MapReduce is a framework for processing vast amounts of data in-parallel on large clusters of computer.

In some embodiments, the co-similarity module 122 generates the matrices described above using edge objects from the edge database 114. In some embodiments, the co-similarity module 122 generates one or more matrices for segments of users. As discussed above, a segment of users may be defined by demographic characteristics such as gender, age, or geographic location. For example, the co-similarity module 122 may generate a matrix for female users, a matrix for users ages 20-30, and a matrix for users who are located in a particular city, state, or country. By generating a matrix for a segment of users rather than for all users, the co-similarity module 122 may increase the relevancy of the similarity scores and may decrease the overall processing time for determining the similarity scores. In some embodiments, the co-similarity module 122 generates one or more matrices for users who are connections of a particular user or who have a profile characteristic in common with the particular user.

### Selecting Advertisements for Users of a Social Networking System Using Collaborative Filtering

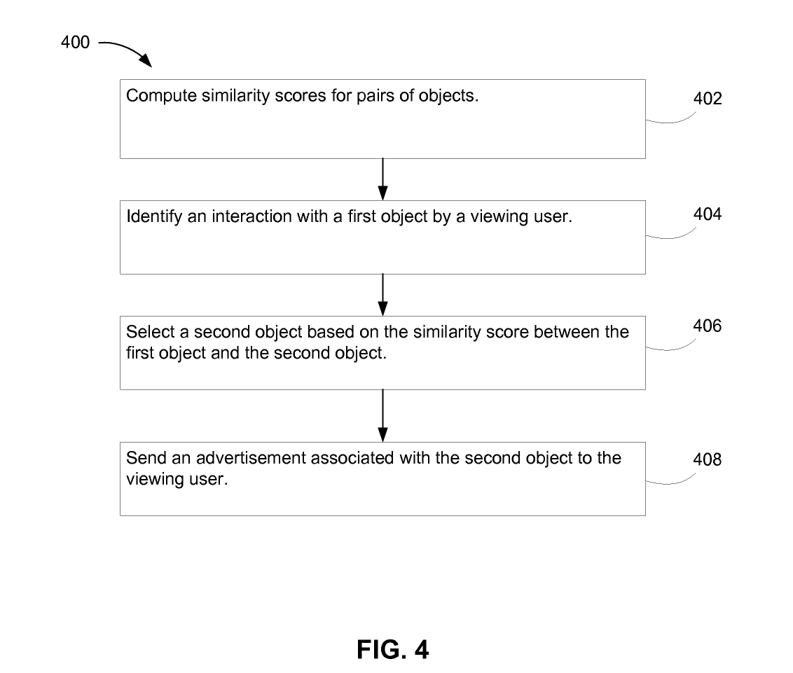

FIG. 4 is a flow chart of a process 400 for selecting advertisements for users of a social networking system using collaborative filtering, in accordance with one embodiment. This process 400 may be performed at a server system (e.g., social networking system 100) having one or more processors and non-transitory memory. The non-transitory memory stores one or more programs to be executed by the one or more processors. The one or more programs include instructions for carrying out the process 400.

In this process 400, similarity scores for pairs of objects in the social networking system are computed 402. A similarity score for a pair of objects is based on a measure of users who have interacted with both of the objects in the pair and is normalized by a number of interactions by the users with one or both of the objects in the pair. The objects may be games, pages, groups, deals, messages, content items, advertisements, or any combination thereof.

In some embodiments, the computing includes generating a user-object interaction matrix data structure that stores a user-object interaction matrix. The user-object interaction matrix includes values for a plurality of user-object pairs. For example, the co-similarity module 122 may generate the user-object interaction matrix 300 shown in FIG. 3A. Computing the similarity score for a pair of object includes obtaining the measure of users who have interacted with both of the pair of objects form the values in the user-object interaction matrix. A user-object pair corresponds to a user's interaction with an object and the value for the user-object pair is based on the user's interaction with the object. In some embodiments, the values of the plurality of user-object pairs include binary values that are based on whether interactions exist between users and objects. In some embodiments, the values for the plurality of user-object pairs include values computed based on types of interactions between users and objects. In some embodiments, the values of the user-object interaction matrix are decayed over time based on times of interactions. In some embodiments, the values of the user-object interaction matrix are decayed over time based on a decay factor. In some embodiments, the user-object interaction matrix is a sparse matrix. In some embodiments, a matrix is a sparse matrix if less than five percent of the values in the matrix are non-zero.

In some embodiments, the similarity scores are computed based on comparing rows of the user-object interaction matrix. For example, as discussed above, a similarity score maybe determined using Formula 1 or Formula 2.

An interaction with a first object by a viewing user is identified 404. In some embodiments, the interaction is identified from an interaction log maintained by the social networking system. The interaction log includes information about a plurality of user interactions with a plurality of objects in the social networking system. The interaction log may be the action log discussed above.

A second object is selected 406 based on the similarity score between the first object and the second object. In some embodiments, the object that has the highest similarity score with the first object is selected. In some embodiments, an object having a similarity score with the first object above a threshold is selected.

An advertisement associated with the second object is sent 408 to the viewing user for display. In some embodiments, the advertisement includes a suggestion to interact with the second object. For example, if the object is a fan page, the advertisement may suggest viewing or posting comments on the fan page.

### Summary

The foregoing description of the embodiments of the invention has been presented for the purpose of illustration; it is not intended to be exhaustive or to limit the systems and methods to the precise forms disclosed. Persons skilled in the relevant art can appreciate that many modifications and variations are possible in light of the above disclosure.

Some portions of this description describe the embodiments of the systems and methods in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the systems and methods may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the systems and methods may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the systems and methods systems and methods be limited not by this detailed description, but rather by any claims that issue on an application based hereon. Accordingly, the disclosure of the embodiments of the systems and methods are intended to be illustrative, but not limiting, of the scope of the invention, which is set forth in the following claims.

What is claimed is:

1. A method comprising:
maintaining an interaction log by a social networking system, the interaction log including information about a plurality of user interactions with a plurality of objects in the social networking system;
computing a similarity score for each of a plurality of pairs of the plurality of objects, each similarity score based on a measure of users who have interacted with both of the pair of objects, normalized by a number of interactions by the users with one or both of the pair of objects;
identifying, from the interaction log, an interaction with a first object of the plurality of objects by a viewing user;
selecting a second object from the plurality of objects based on the similarity score between the first and the second object; and
sending an advertisement associated with the second object for display to the viewing user.

2. The method of claim 1, further comprising:
generating a user-object interaction matrix data structure from the interaction log, the user-object interaction matrix data structure storing a user-object interaction matrix, the user-object matrix including values for a plurality of user-object pairs,
wherein computing the similarity score for a pair of objects comprises obtaining the measure of users who have interacted with both of the pair of objects from the values in the user-object interaction matrix.

3. The method of claim 2, wherein the values for the plurality of user-object pairs comprise binary values, and wherein each binary value indicates whether an interaction exists between a user and an object.

4. The method of claim 2, wherein the values for the plurality of user-object pairs comprise non-binary values computed based on a measure of the interactions between users and objects.

5. The method of claim 4, wherein the values are decayed based on an age of the corresponding interactions.

6. The method of claim 2, wherein the user-object interaction matrix data is a sparse matrix.

7. The method of claim 2, wherein the similarity score is computed based on comparing rows of the user-object interaction matrix.

8. The method of claim 2, wherein is the similarity score is computed using one or more map and reduce steps.

9. The method of claim 1, wherein the similarity scores are computed based on interactions of only those users who are part of a segment of all users of the social networking system.

10. The method of claim 9, wherein the segment of users is defined by at least one of gender, age, and geographic location.

11. The method of claim 1, wherein the plurality of objects are selected from a group consisting of: games, pages, groups, deals, content items, messages, advertisements, and any combination thereof.

12. The method of claim 1, wherein the advertisement includes a suggestion to interact with the second object.

13. The method of claim 1, wherein the similarity score for a pair of objects is determined based on the formula:
$$\frac{Object A ⋂ Object B}{\sqrt{( Object A ) ( Object B )}} ,$$
where Object A ∩Object B comprises a measure of users who have interacted with both the first and second objects, Object A comprises a measure of users who have interacted with the first object, and Object B comprises a measure of users who have interacted with the second object.

14. A non-transitory computer readable storage medium storing one or more programs configured to be executed by a server system, the one or more programs comprising instructions for:
maintaining an interaction log by a social networking system, the interaction log including information about a plurality of user interactions with a plurality of objects in the social networking system;
computing a similarity score for each of a plurality of pairs of the plurality of objects, each similarity score based on a measure of users who have interacted with both of the pair of objects, normalized by a number of interactions by the users with one or both of the pair of objects;
identifying, from the interaction log, an interaction with a first object of the plurality of objects by a viewing user;
selecting a second object from the plurality of objects based on the similarity score between the first and the second object; and
sending an advertisement associated with the second object for display to the viewing user.

15. A method comprising:
maintaining an interaction log by a social networking system, the interaction log including information about a plurality of user interactions with a plurality of objects in the social networking system;
computing a similarity score between a first object and a second object, the similarity score based on a measure of users who have interacted with both the first object and the second object, normalized by a number of interactions by users with one or both of the first object and the second object.
identifying, from the interaction log, an interaction with a first object by a viewing user;
selecting the second object from the plurality of objects based on the similarity score between the first object and the second object; and
sending an advertisement associated with the second object for display to the viewing user.
